(19) United States
(12) Patent Application Publication
(10) Pub. No.: US 2018/0346227 A1
(43) Pub. Date: Dec. 6, 2018

(54) ASSEMBLY COMPRISING A FOIL PACK AND A DISPENSING DEVICE AND FOIL PACK

(71) Applicant: HILTI AKTIENGESELLSCHAFT, Schaan (LI)

(72) Inventors: Matthias WOLF, Gilching (DE); Wolfgang LUDWIG, Zaisertshofen (DE)

(73) Assignee: Hilti Aktiengesellchaft, Schaan (LI)

(21) Appl. No.: 15/778,716

(22) PCT Filed: Dec. 13, 2016
(86) PCT No.: PCT/EP2016/080720

§ 371 Date: May 24, 2018

(30) Foreign Application Priority Data
Dec. 18, 2015 (EP) 15201024.5

(51) Int. Cl. B65D 81/32; B65D 83/00; B05C 17/005

(52) U.S. Cl. CPC B65D 81/3244; B65D 83/0055; B05C 17/00583; B05C 17/00503; B05C 17/00556

(57) ABSTRACT

An assembly can be used for packaging chemical compounds. The assembly includes a foil pack for storage of a one-component or multicomponent compound, and a dispensing device for the foil pack. The foil pack has at least one elongated foil bag designed to be non-rigid, and one rigid head part having at least one fastening portion for one end of the foil bag and an outlet opening for discharge of the compound, where the dispensing device has at least one receptacle for pushing in the at least one film bag. The at least one elongated foil bag has, in a filled condition, the form of a truncated cone, the diameter of which narrows in the direction of a longitudinal axis, starting from the respective fastening portion.

The invention relates to an assembly comprising a foil pack for storing a one-component or multicomponent compound and a dispensing device for the foil pack, wherein the foil pack has at least one elongated foil bag designed to be intrinsically non-rigid and one intrinsically rigid head part with at least one fastening portion for one end of the foil bag and an outlet opening for letting out the compound, and wherein the dispensing device has at least one receptacle for pushing in the at least one foil bag. Furthermore, the invention relates to a foil pack for such an assembly, with at least one elongated foil bag designed to be intrinsically non-rigid and one intrinsically rigid head part with at least one fastening portion for one end of the foil bag.

Such foil packs have proved useful in the past as packaging for chemical compounds, such as, for example, mortar, foam, plugging or sealing compounds that consist of one or more components. In particular, compared with cartridges, they are characterized by more cost-effective and simpler manufacturing as well as by a smaller proportion of material to be disposed of after use.

To apply the compound, the foil pack is usually pushed into a receptacle of a squeezing-out device, for example a dispenser. Via a dispensing mechanism, the one-component or multicomponent compound is dispensed through an outlet opening in the head part and then (at least in the case of a multicomponent compound) is passed for better mixing through a mixer attachment having a mixer element.

DE 10 2008 040 738 A1 discloses a foil pack of the type mentioned in the introduction, which has two foil bags disposed laterally alongside one another, is able to receive the two-component and multicomponent compounds and is suitable for being pushed into a dispensing device having two receptacles disposed alongside one another.

In order to permit the foil pack to be pushed axially into the receptacle without problems, a gap is needed between the outside wall of the foil and the inside wall of the receptacle. During emptying of the foil pack, for example by means of a plunger that can be displaced in the receptacle, the foil of the foil bag or bags is stretched, whereby the foil comes to bear on the inside wall of the receptacle. In the process, the foil is widened, and the optionally different foils of the individual bags are subjected to different stresses, which lead to uneven squeezing of the various components during relaxation of the pressure. This expansion and recovery of the foil bags is also known as pumping, which leads to discrepancies in the mixing ratio, especially during the startup behavior.

It is therefore an object of the invention to provide a foil pack or an assembly comprising foil pack and dispensing device, in which the undesired expansion and recovery of the foils is effectively prevented.

According to a first aspect of the invention, it is provided for this purpose in an assembly of the type mentioned in the introduction that the at least one foil bag has, in the filled condition, the form of a truncated cone, the diameter of which narrows in the direction of its longitudinal axis, starting from the fastening portion, and that the at least one receptacle has a frustoconical inner circumferential wall, which in particular is shaped to be complementary to the foil bag, wherein the at least one foil bag, in the fully pushed-in condition, bears with full surface contact on the inner circumferential wall of the receptacle.

In the inventive configuration, therefore both the at least one foil bag and the associated receptacle have slightly inclined circumferential walls, which makes it possible to push the foil bag into the associated receptacle even without providing a joint gap. After the foil bag has been completely pushed in, the foil outside wall bears with full surface contact on the inside wall of the receptacle, whereby expansion and recovery of the foil bag during emptying is reliably prevented. In the completely pushed-in condition, the inner circumferential wall of the receptacle offers complete support for the foil bag, and so this cannot experience any expansion even under pressure and thus also no recovery occurs. In this way, the undesired pumping is avoided. Moreover, compared with a foil bag of plain cylindrical construction, much easier pushing in is possible due to the inclination.

According to a preferred embodiment, the cone angle or opening angle of the truncated cone lies in the range of 0.1° to 10°, especially of 2° to 6°. Thus the foil bag or bags as well as the receptacle(s) are provided only with a slight inclination, whereby introduction is facilitated and a joint gap can be avoided. At the same time, an only slight inclination of the circumferential walls permits reliable dispensing of the contained compound(s) by means of a plunger (each) guided in the receptacle. Since the diameter of the foil bag increases only slightly from the end at which the plunger is applied to the other end fixed to the fastening portion of the foil bag, the foil bag is completely emptied even by use of a conventional plunger.

According to a preferred embodiment, the foil pack has a first foil bag and a second foil bag disposed alongside the first foil bag for components of a multicomponent compound stored separately from one another, wherein both foil bags have frustoconical shape. In this way the foil pack is suitable for storage of a two-component compound, which is intermixed only during dispensing. Naturally, it is possible to provide several bags for storage of more than two components, or alternatively to form one or more foil bags with several chambers, in which several different components can be stored separately from one another.

Preferably, the head part then has a first fastening portion for one end of the first foil bag and a second fastening portion disposed laterally alongside it for one end of the second foil bag, especially wherein a straight-through duct is provided from each foil bag in the head part and the straight through ducts in the head part discharge into a common outlet opening. Usually a mixer attachment is screwed onto the outlet opening, which ensures simple mixing of the two or more components stored in the two foil bags directly during dispensing.

In this connection, the dispensing device preferably has a first receptacle for the first foil bag and a second receptacle disposed laterally alongside it for the second foil bag, wherein both receptacles have inner circumferential walls tapering conically in the direction of their longitudinal axis. Thus reliable full-surface support of the outside walls of both foil bags is ensured.

In a preferred embodiment, the two foil bags have the same cone angle and therefore the same inclination relative to the longitudinal axis, which from the production-related viewpoint is more favorable, especially in regard to the associated receptacles.

Alternatively, the two frustoconical foil bags may have different cone angles. What is decisive is that the respective associated receptacle has a cone angle matched to the cone angle of the foil bag.

In particular, the two foil bags are produced from foils with different mechanical properties. By virtue of the full-surface support of the foil bags in the respective receptacle, expansion and recovery of the foil bags is indeed reliably prevented, and so matching of the mechanical properties of the various foil bags is no longer necessary in the inventive configuration.

In a preferred configuration of the invention, the first foil bag has a greater diameter along its entire length than does the second foil bag. For the same length, therefore, the first foil bag has a greater volumetric capacity, which permits a mixing ratio of the two components different from 1:1 ratio. In principle, any desired mixing ratio of the components can be achieved via the diameter of the bags.

According to a second aspect of the invention, the object stated hereinabove is likewise solved by a foil pack of the type mentioned in the introduction, in which the at least one receptacle has, in the filled condition, the form of a truncated cone, the diameter of which decreases in the direction of its longitudinal axis, starting from the fastening portion. Such a foil pack can also be pushed without problems into the receptacle of a dispensing device even without providing a joint gap, and it permits the foil bag in the completely pushed-in condition to bear with full surface contact on an inner circumferential wall of the receptacle, whereby the undesired expansion and recovery of the foil bag is reliably prevented during dispensing of the compound from the foil bag.

In a preferred embodiment, the foil pack has a first foil bag and a second foil bag disposed alongside the first foil bag for components of a multicomponent compound stored separately from one another, wherein both foil bags have frustoconical shape. This permits storage and preparation of multicomponent compounds.

Preferably, the head part has a first fastening portion for one end of the first foil bag and a second fastening portion disposed laterally alongside it for one end of the second foil bag, especially wherein a straight-through duct is provided from each foil bag in the head part and the straight through ducts in the head part discharge into a common outlet opening. Thereby space-saving storage and simple mixing of a two-component compound are achieved.

Beyond this all improvements and advantages mentioned with reference to the inventive assembly are also valid for the inventive foil pack and vice versa.

Further features and advantages will become apparent from the description hereinafter of a preferred embodiment on the basis of the attached drawings, wherein:

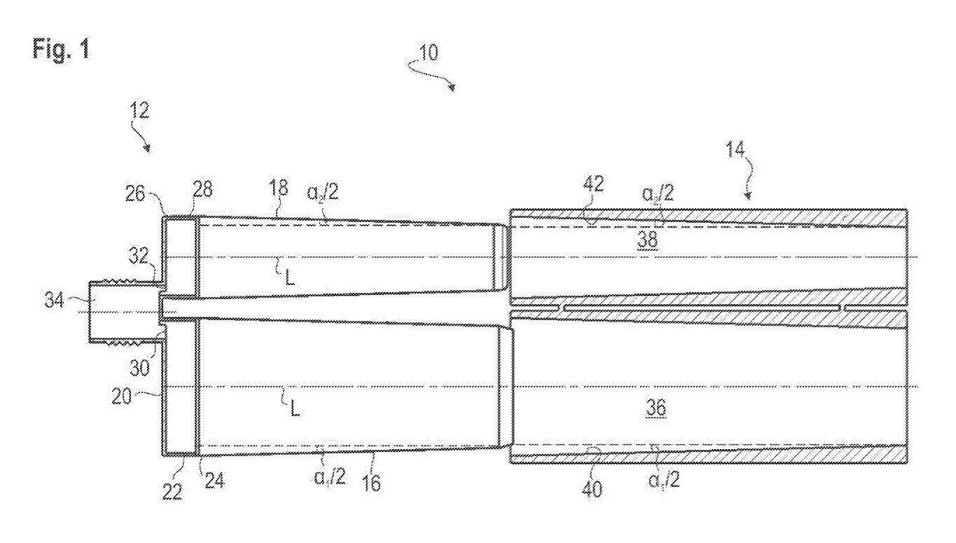

FIG. 1 shows a sectional view of an inventive assembly before the foil pack is pushed into the dispensing device;

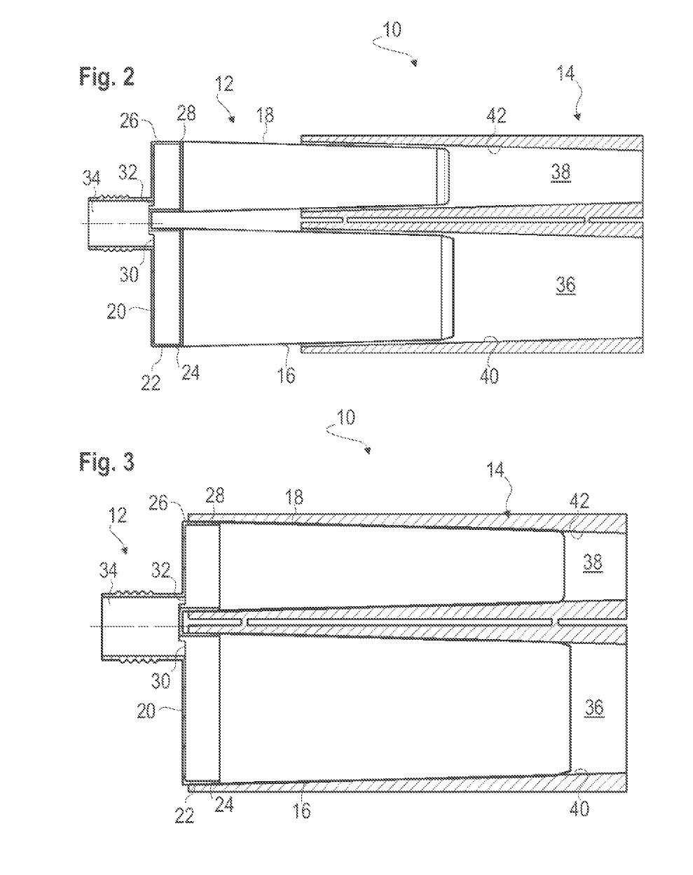

FIG. 2 shows a sectional view of the assembly from FIG. 1, wherein the foil pack is partly pushed into the dispensing device, and

FIG. 3 shows a sectional view of the inventive assembly in an end position, in which the foil pack has been pushed completely into the dispensing device.

FIGS. 1 to 3 show an inventive assembly 10, which is provided with a foil pack 12 for storage of in this case a two-component compound and with a dispensing device 14 for foil pack 12.

Foil pack 12 comprises a first filled foil bag 16 as well as a second, filled foil bag 18 disposed laterally alongside first foil bag 16, which bags are used to retain the components of the two-component compound in storage separately from one another. Foil bags 16, 18 themselves are elongated and (without contents) are designed to be intrinsically non-rigid.

Furthermore, foil pack 12 comprises an intrinsically rigid head part 20, which has a first fastening portion 22, on which one end 24 of first foil bag 16 is fixed. A second fastening portion 26 for one end 28 of second foil bag 18 is provided laterally alongside first fastening portion 22. Both foil bags 16, 18 are undetachably fixed on head part 20. Beyond this, two straight-through ducts 30, 32 are formed in head part 20, each of which joins one of the foil bags 16, 18 with a common outlet opening 34. A mixer attachment (not shown) is usually screwed onto this.

Both foil bags 16, 18 have the form of a truncated cone, the diameter of which narrows in the direction of a longitudinal axis L of the foil bags 16, 18, starting from the respective fastening portion 22 or 26. In this connection, both the cone angle α₁ of first foil bag 16 and the cone angle α₂ of second foil bag 18 lie in the range of 0.1° to 10°, especially of 2° to 6°. In the shown embodiment, both cone angles α₁ and α₂ are approximately 4°, as is evident in FIG. 1, in which, for space reasons, the angles of inclination α₁/2 and α₂/2, which indeed correspond exactly to the respective half cone angle, are indicated instead of the actual cone angles α₁ and α₂.

First foil bag 16 has a greater diameter along its entire length than does second foil bag 18, as can be inferred from the figures. Consequently, first foil bag 16 has a larger volume of the two-component compound, whereby this component predominates in the finish-mixed compound. In principle, the mixing ratio of the two-component compound is adjustable via the volume or diameter ratio of foil bags 16, 18.

Dispensing device 14, which is shown only partly in the figures (without illustration of the actual dispensing mechanism, for example in the form of one or more plungers), has a first receptacle 36 for first foil bag 16 as well as a second receptacle 38, disposed laterally alongside it, for second foil bag 18. Both receptacles 36, 38 have a frustoconical inner circumferential wall 40 and 42 shaped to be complementary to the associated foil bag 16, 18 and respectively tapering conically in the direction of longitudinal axis L. The cone angles α₁, α₂ of these internal circumferential walls 40, 42 correspond to those of the respectively associated foil bags 16, 18.

FIG. 2 shows a middle position, in which foil pack 12 is partly pushed approximately halfway into dispensing device 14. By virtue of the frustoconical shape both of foil bags 16, 18 and of receptacles 36, 38, there is no need here to provide a joint gap, as is known for conventional plain cylindrical foil bags. In addition, pushing in is simpler because of the inclination of the participating walls.

Finally, FIG. 3 illustrates the end position 16, 18, in which both foil bags are completely pushed into the respective associated receptacle 36, 38. In this completely pushed-in condition, both foil bags 16, 18 bear with full surface contact on the respective internal circumferential wall 40 or 42 of the associated receptacle 36, 38.

By virtue of this complete support or full surface contact in the end position, no matching of the mechanical properties is needed in the inventive embodiment, and so the two foil bags 16, 18 may be made from foils with different mechanical properties.

1: An assembly, comprising:
a foil pack for storage of a one-component or multicomponent compound, and
a dispensing device for the foil pack,
wherein the foil pack has
at least one elongated foil bag designed to be non-rigid, and
one rigid head part comprising at least one fastening portion for one end of the foil bag and an outlet opening for discharge of the compound,
wherein the dispensing device has at least one receptacle for pushing in the at least one film bag,
wherein the at least one elongated foil bag has, in a filled condition, the form of a truncated cone, the diameter of which narrows in the direction of a longitudinal axis, starting from f-em the respective fastening portion,
wherein the at least one receptacle has a frustoconical inner circumferential wall, which is shaped complementary to the foil bag, and
wherein, in a fully pushed-in condition, the foil bag bears with full surface contact on the inner circumferential wall of the receptacle.

2: The assembly according to claim 1, wherein
the truncated cone has a cone angle in a range of from 0.1° to 10°.

3: The assembly according to claim 1, wherein
the foil pack has a first foil bag and a second foil bag disposed alongside the first foil bag for components of a multicomponent compound stored separately from one another, and
wherein each foil bag has frustoconical shape.

4: The assembly according to claim 3, wherein
the head part has a first fastening portion for one end of the first foil bag and a second fastening portion disposed laterally alongside the head part for one end of the second foil bag.

5: The assembly according to claim 3, wherein
the dispensing device has a first receptacle for the first foil bag and a second receptacle disposed laterally alongside it for the second foil bag, and
wherein each receptacle has an inner circumferential wall tapering conically in a direction of a longitudinal axis thereof.

6: The assembly according to claim 3, wherein
a cone angle of each foil bag is the same.

7: The assembly according to claim 3, wherein
each foil bag comprises a foil that has different mechanical properties from each other foil in each other foil bag.

8: The assembly according to claim 3, wherein
the first foil bag has a greater diameter along an entire length thereof, compared to a diameter of the second foil bag.

9: A foil pack for an assembly, the foil pack comprising:
at least one elongated foil bag designed to be non-rigid as well as a rigid head part with at least one fastening portion for one end of the foil bag, wherein
the at least one foil bag has, in a filled condition, a form of a truncated cone, the diameter of which narrows in a direction of a longitudinal axis thereof, starting from the fastening portion.

10: The foil pack according to claim 9, wherein
the foil pack has a first foil bag and a second foil bag disposed alongside the first foil bag for components of a multicomponent compound stored separately from one another, and
wherein each foil bag have has a frustoconical shape.

11: The foil pack according to claim 9,
the head part has a first fastening portion for one end of the first foil bag and a second fastening portion disposed laterally alongside it for one end of the second foil bag.

12: The assembly according to claim 1, wherein
the truncated cone has a cone angle in a range of from 2° to 6°.

13: The assembly according to claim 3, wherein
the head part has a first fastening portion for one end of the first foil bag and a second fastening portion disposed laterally alongside the head part for one end of the second foil bag,
wherein a straight-through duct is provided from each foil bag in the head part, and
wherein the straight through ducts in the head part discharge into a common outlet opening.

14: The foil pack according to claim 9,
the head part has a first fastening portion for one end of the first foil bag and a second fastening portion disposed laterally alongside the head part for one end of the second foil bag,
wherein a straight-through duct is provided from each foil bag in the head part, and
wherein the straight through ducts in the head part discharge into a common outlet opening.
